(19) United States
(12) Patent Application Publication
(10) Pub. No.: US 2009/0027922 A1
(43) Pub. Date: Jan. 29, 2009

(54) Power adapter

(76) Inventors: Mark S. Tracy, Tomball, TX (US); Jonathan R. Harris, Cypress, TX (US); Paul J. Doczy, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/880,787

(22) Filed: Jul. 24, 2007

(51) Int. Cl. H02M 7/00

(52) U.S. Cl. 363/13

(57) ABSTRACT

A power adapter comprises a converter module having circuitry for converting an alternating current (AC) power supply to a direct current (DC) power supply, a connector couplable to an electronic device for supplying the DC power supply to the electronic device, and a switch manually actuatable to control power consumption by the power adapter.

### BACKGROUND

Many portable electronic devices that can be operated by a direct current (DC) power supply (e.g., by an onboard and/or attachable battery) are configured to accept a connection to a power adapter to enable an alternating current (AC) power supply to be used to power the electronic device and/or recharge the battery. For example, such power adapters generally convert AC power (e.g., received via an AC electrical outlet) to DC power for use by the electronic device and/or battery recharging. However, the power adapter is also a source of energy loss as the power adapter generally continues to draw power from an electrical source (e.g., an electrical outlet) even though the power adapter may not be currently recharging a battery or powering the electronic device.

### BRIEF DESCRIPTION OF THE DRAWINGS

FIG. 1 is a diagram illustrating an electronic device to which an embodiment of a power adapter is connected and used to advantage; and

FIG. 2 is an enlarged view of a portion of the power adapter of FIG. 1.

### DETAILED DESCRIPTION OF THE DRAWINGS

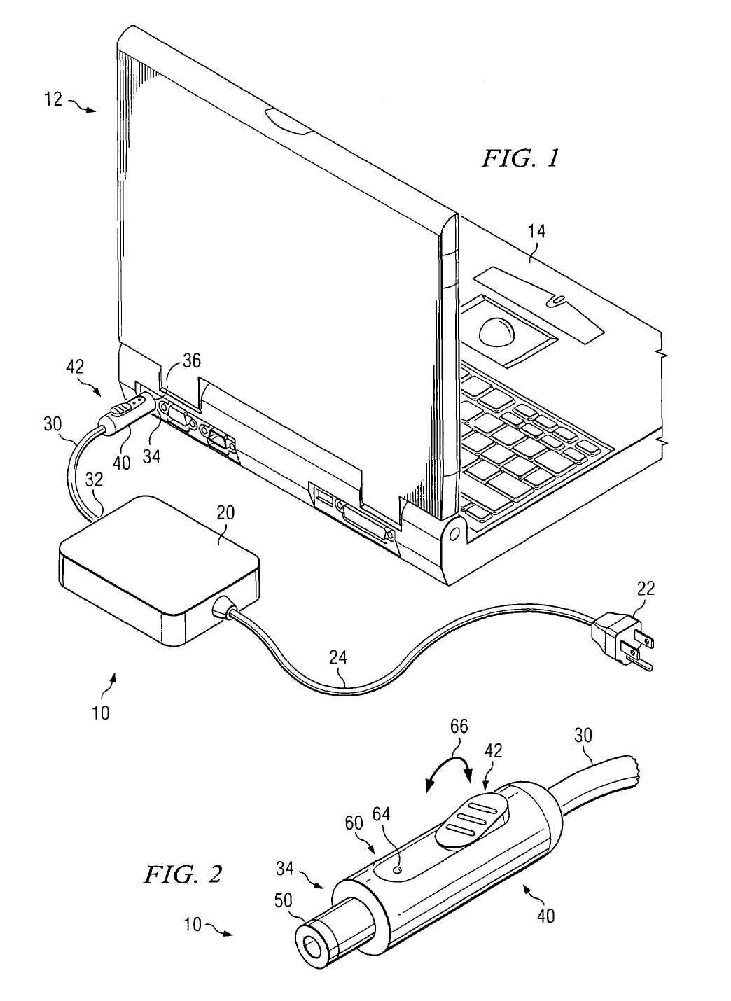

The preferred embodiments and the advantages thereof are best understood by referring to FIGS. 1 and 2 of the drawings, like numerals being used for like and corresponding parts of the various drawings.

FIG. 1 is a diagram illustrating an embodiment of a power adapter 10. In FIG. 1, power adapter 10 is illustrated as being used in connection with an electronic device 12. In FIG. 1, electronic device 12 comprises a lap top or notebook computer 14. However, it should be understood that electronic device 12 may comprise any type of electronic device such as, but not limited to, a cellular telephone, a gaming device, a docking station, a portable drive, or any other type of portable or non-portable electronic device.

In the embodiment illustrated in FIG. 1, power adapter 10 comprises a converter module 20 for storing therein various circuitry for converting an alternating current (AC) power supply to a direct current (DC) power supply for use with electronic device 12. For example, in some embodiments, electronic device 12 may be powered using an onboard or attachable DC power supply such as an onboard and/or attachable battery. Power adapter 10 is configured to convert an AC power supply to a DC power supply for use by electronic device 12 for operating electronic device 12 and/or recharging a battery associated with electronic device 12. For example, in the embodiment illustrated in FIG. 1, power adapter 10 comprises a plug or connector 22 couplable to an AC power supply such as, but not limited to, an electrical outlet disposed on a wall, floor, etc. In the embodiment illustrated in FIG. 1, a cord 24 acting as an electrical conduit connects connector 22 to converter module 20 and provides for a flow of the AC power supply from connector 22 to converter module 20, where circuitry within converter module 20 converts the AC power to DC power. However, it should be understood that, in some embodiments, power adapter 10 may be formed and/or otherwise manufactured without cord 24 (e.g., locating connector 22 on converter module 20 such that converter module 20 and connector 22 are pluggable and/or couplable as a unit to an AC power supply).

In the embodiment illustrated in FIG. 1, power adapter 10 comprises a cord 30 having an end 32 communicatively coupled to converter module 20 and associated circuitry disposed therein and an opposite end 34 couplable to electronic device 12 at, for example, a DC power-in port 36 of electronic device 12. In the embodiment illustrated in FIG. 1, power adapter 10 comprises a connector 40 disposed at end 34 for connecting with electronic device 12 at port 36. In FIG. 1, power adapter 10 also comprises a switch 42 that is actuatable to control an on/off mode of power adapter 10. For example, in some embodiments, switch 42 is used to turn power adapter 10 on and off, thereby controlling the power drawn and/or otherwise consumed by power adapter 10 (e.g., the power drawn from an AC power supply). In the embodiment illustrated in FIG. 1, switch 42 comprises a manually actuatable switch 42 to enable a user of power adapter 20 to physically actuate switch 42 to change the on/off mode of power adapter 10 (e.g., turning power adapter 10 on or turning power adapter 10 off).

In FIG. 1, switch 42 is located proximate and/or near end 34 of cord 30 to facilitate ready access thereto by a user of power adapter 10. For example, in some uses, power adapter 10 may be located on a floor, under a desk, etc., such that cord 30 extends from converter module 20 to a location where electronic device 12 may be used (e.g., on top of a desk, adjacent a display device, etc.) to enable connector 40 to be readily accessed and plugged into port 36 of electronic device 12. Thus, in some embodiments, switch 42 is located proximate and/or near end 34 of cord 30 to facilitate ready access to switch 42 by a user. However, it should be understood that switch 42 may be otherwise located (e.g., at other locations along cord 30, on converter module 20, at a location along cord 24, a location proximate and/or near connector 22, etc.). Thus, in the embodiment illustrated in FIG. 1, switch 42 is electrically and/or communicatively coupled to circuitry disposed within converter module 20 via cord 30.

FIG. 2 is an enlarged diagram illustrating a portion of power adapter 10. In the embodiment illustrated in FIG. 2, connector 40 comprises a plug portion 50 insertable into port 36 (FIG. 1) of electronic device 12 to facilitate a DC power supply to electronic device 12. In the embodiment illustrated in FIG. 2, switch 42 is disposed and/or otherwise located on and/or forms part of connector 40. However, it should be understood that switch 42 may be formed as a separate and/or discrete component of power adapter 10 apart from connector 40. In FIG. 2, switch 42 comprises a two-position switch 42 that is actuatable between two different positions (e.g., one position corresponding to an “off” mode and the other position corresponding to an “on” mode of power adapter 10). However, it should be understood that different types of manually actuatable switches 42 may be used (e.g., a push button mechanism, a slideable mechanism, etc.).

In the embodiment illustrated in FIG. 2, power adapter 10 also comprises an indicator 60 for displaying the on/off mode status of power adapter 10. For example, in some embodiments, indicator 60 comprise a light emitting diode (LED) 64 that is illuminated to visually indicate to a user the on/off mode status of power adapter 10 (e.g., an illuminated LED 64 indicating an “on” mode of power adapter 10). However, it should be understood that other types of visual indicators may be used (e.g., indicia located on switch 42). In FIG. 2, a single indicator 60 is illustrated; however, it should be understood that additional indicators may be used.

Thus, in operation, in the embodiment illustrated in FIGS. 1 and 2, switch 42 is physically actuatable by a user in the directions indicated by arrow 66 to change the on/off mode of power adapter 10. For example, switch 42 is actuatable by the user to place power adapter 10 in an “off” mode to thereby cease and/or otherwise prevent power from being drawn from an AC power supply while power adapter 10 is plugged into the AC power supply (regardless of whether power adapter 10 is connected to electronic device 12). Thus, for example, in some embodiments, after disengagement of electronic device 12 from power adapter 10, switch 42 may be actuated to place power adapter 10 in an “off” mode while power adapter 10 remains plugged into an AC power supply source, thereby preventing power from being drawn by power adapter 10 from the AC power supply source. Further, upon engagement of electronic device 12 with power adapter 10, switch 42 may be readily actuated by a user to place power adapter 10 in an “on” mode to thereby draw power from an AC power supply source and convert the AC power to provide a source of DC power to electronic device 12. In the above examples, it should be understood that actuation of switch 42 to change the on/off mode of power adapter 10 may be made before and/or after engagement/disengagement of electronic device 12 with power adapter 10. Additionally, based on the foregoing, it should be understood that even while power adapter is plugged into electronic device 12, power adapter 10 may be placed in the “off” mode by user-actuation of switch 42, thereby preventing a power draw by power adapter 10 from the AC power supply source.

Thus, embodiments of power supply 10 facilitate energy conservation by enabling a user to place power adapter 10 in an “off” mode while power adapter 10 remains plugged into a source of AC power.

What is claimed is:

1. A power adapter, comprising:
a converter module having circuitry for converting an alternating current (AC) power supply to a direct current (DC) power supply;
a connector couplable to an electronic device for supplying the DC power supply to the electronic device; and
a switch manually actuatable to control power consumption by the power adapter.

2. The power adapter of claim 1, wherein the switch is disposed on the connector.

3. The power adapter of claim 1, further comprising a cord having a first end coupled to the converter module and a second end couplable to the electronic device, the switch located proximate the second end of the cord.

4. The power adapter of claim 1, wherein the switch is actuatable to cease power draw from the AC power supply.

5. The power adapter of claim 1, further comprising at least one indicator displaying a power mode status of the switch.

6. The power adapter of claim 1, further comprising at least one light emitting diode (LED) displaying a power mode status of the switch.

7. The power adapter of claim 1, wherein the switch is configured to control a draw of power from the AC power supply.

8. A power adapter, comprising:
a first connector couplable to an alternating current (AC) power supply and a second connector couplable to an electronic device, the power adapter configured to convert the AC power supply to a direct current (DC) power supply; and
a manually actuatable switch located proximate the second connector for controlling an on/off mode of the power adapter.

9. The power adapter of claim 8, wherein the switch is disposed on the second connector.

10. The power adapter of claim 8, further comprising at least one indicator displaying a status of the on/off mode.

11. The power adapter of claim 8, further comprising at least one light emitting diode (LED) displaying a status of the on/off mode.

12. The power adapter of claim 8, further comprising at least one indicator disposed on the second connector and displaying a status of the on/off mode.

13. A power adapter, comprising:
a connector couplable to an alternating current (AC) power supply, the power adapter configured to convert the AC power supply to a direct current (DC) power supply; and
a manually actuatable switch configured to control an on/off mode of the power adapter while the connector is coupled to the AC power supply.

14. The power adapter of claim 13, further comprising another connector couplable to an electronic device.

15. The power adapter of claim 13, further comprising a cord extending from a converter module of the power adapter to another connector couplable to an electronic device, the switch located proximate to the another connector.

16. The power adapter of claim 13, further comprising at least one indicator displaying a status of the on/off mode.

17. The power adapter of claim 13, further comprising at least one indicator disposed on the switch and displaying a status of the on/off mode.

18. The power adapter of claim 13, wherein the switch is located on another connector of the power adapter couplable to an electronic device.

19. The power adapter of claim 13, wherein the switch is configured to control a draw of power from the AC power supply while the connector is coupled to the AC power supply.

20. The power adapter of claim 13, wherein the switch is configured to prevent a draw of power from the AC power supply while the connector is coupled to the AC power supply.

21. A power adapter, comprising:
means couplable to an electronic device for converting an alternating current (AC) power supply to a direct current (DC) power supply; and
a manually actuatable means for controlling an on/off mode of the power adapter while the power adapter is coupled to the AC power supply.
